(19) United States
(12) Patent Application Publication
(10) Pub. No.: US 2021/0118022 A1
(43) Pub. Date: Apr. 22, 2021

(54) SYSTEMS AND METHODS FOR AUTOMATED USED CAR PRICING

(71) Applicant: TKO Auto LLC, Stanton, CA (US)

(72) Inventors: Victor BALIKJIAN, Anaheim, CA (US); Anthony Nino, Corona, CA (US)

(21) Appl. No.: 17/073,255

(22) Filed: Oct. 16, 2020

Related U.S. Application Data
(60) Provisional application No. 62/916,632, filed on Oct. 17, 2019.
(60) Provisional application No. 62/916,635, filed on Oct. 17, 2019.
(60) Provisional application No. 62/916,638, filed on Oct. 17, 2019.

(51) Int. Cl. G06Q 30/02; G06Q 30/06

(52) U.S. Cl. CPC G06Q 30/0283; G06Q 30/0643; G06Q 30/0611; G06Q 30/0206

(57) ABSTRACT

A system comprises a device comprising an application and a display, the application configured to present a user interface on the display that allows a user to provide user information, vehicle information and vehicle condition information; a platform in communication with the device, with at least one storage location, and third party platforms, the platform configured to: receive the user information, vehicle condition information in relation to a request for quote to purchase a car; parse the user information, vehicle information and condition information; generating one or more requests for related vehicle information that are sent to the third party platforms; receive the related vehicle information; generate a quote for the car based on the user information, vehicle information, condition information, and the related information; and estimate a second payment that is equal to a percentage of the difference between the quote and an action price for the car.

### BACKGROUND

### 1. Technical Field

The embodiments described herein are related to systems and methods for facilitating transactions, and more particularly to a platform and API's for use in used car transactions.

### 2. Related Art

New-vehicle sales hog all the attention, for a good reason: They support a large part of the US economy—manufacturing, transportation by rail and truck, port operations, new-vehicle dealers, the finance and insurance business, the whole auto subprime industry, and so on. But with about 17 million vehicles sold a year, the new vehicle market is dwarfed by the used vehicle market. About 40 million used vehicles will be sold in 2018. The 16,800 new-vehicle franchised dealers will likely sell about 15.5 million used vehicles, and the 23,000 or so independent dealers will likely sell over 25 million used vehicles.

The used-vehicle market forms the foundation of the new-vehicle market. High used vehicle prices are essential for high trade-in values, and high trade-in values are essential for high new vehicle sales. The used-vehicle market is where rental cars and lease turn-ins end up. These usually recent-model and low-mileage vehicles compete with new vehicles, often on the same franchised dealer's lot. Low wholesale prices make these vehicles attractive to dealers, because they increase their used-vehicle margins. Although, such sales can cut into new vehicle sales as customers get switched from new to used.

Typically, when a consumer wants to sell or trade-in their used car to dealer, the dealer will check various databases such as Kelley Blue Book, CARFAX or Autocheck, and Manheim Market Report (MMR) to determine an appropriate wholesale value for the car based on its condition and history. The dealer will then either resell the car at a higher retail price on their lot or at auction. Manheim, which runs millions of vehicles a year through its auction sites spread around the US, bases its index and pricing model on the transaction prices at its auctions.

### SUMMARY

Systems and methods for facilitating used cars sales are described herein.

According to one aspect, a system comprises a device comprising an application and a display, the application configured to present a user interface on the display that allows a user to provide user information, vehicle information and vehicle condition information; a platform in communication with the device, with at least one storage location, and third party platforms, the platform configured to: receive the user information, vehicle information and vehicle condition information in relation to a request for quote to purchase a car; parse the user information, vehicle information and vehicle condition information; generating one or more requests for related vehicle information that are sent to the third party platforms; receive the related vehicle information; generate a quote for the car based on the user information, vehicle information, vehicle condition information, and the related information; and estimate a second payment that is equal to a percentage of the difference between the quote and an action price for the car.

According to another aspect, a system comprises a device comprising an application and a display, the application configured to present a user interface on the display that allows a user to provide user information, vehicle information and vehicle condition information, wherein the device comprises a camera and wherein at least some of the user information, vehicle information and vehicle condition information are obtained via the camera; a platform in communication with the device, with at least one storage location, and third party platforms, the platform configured to: receive the user information, vehicle information and vehicle condition information in relation to a request for quote to purchase a car; parse the user information, vehicle information and vehicle condition information, wherein the platform is configured to parse the user information, vehicle information and vehicle condition information using computer vision and/or image analytics; generating one or more requests for related vehicle information that are sent to the third party platforms; receive the related vehicle information; and generate a quote for the car based on the user information, vehicle information, vehicle condition information, and the related information.

According to still another aspect, a system comprises a device comprising an application and a display, the application configured to present a user interface on the display that allows a user to provide user information, vehicle information and vehicle condition information, wherein the device comprises a camera and wherein at least some of the user information, vehicle information and vehicle condition information are obtained via the camera; a platform in communication with the device, with at least one storage location, and third party platforms, the platform configured to: receive the user information, vehicle information and vehicle condition information in relation to a request for quote to purchase a car; parse the user information, vehicle information and vehicle condition information, wherein the platform is configured to parse the user information, vehicle information and vehicle condition information using computer vision and/or image analytics; generating one or more requests for related vehicle information that are sent to the third party platforms; receive the related vehicle information; and generate a quote for the car based on the user information, vehicle information, vehicle condition information, and the related information, wherein the platform is further configured to automatically deposit the quoted amount and the second payment directly into an account associated with the user, or to automatically credit an account associated with the user.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example system for automatically determining a used car quote in accordance with one embodiment;

FIG. 2 is a flow chart illustrating an example process for uploading user and car information via an application within the system of FIG. 1 in accordance with one embodiment;

FIG. 3 is a flow chart illustrating an example process for automatically generating a quote within the system of FIG. 1 in accordance with one embodiment;

FIG. 4 illustrates an example infrastructure in which one or more of the disclosed processes may be implemented, according to an embodiment; and

FIG. 5 is a block diagram illustrating an example wired or wireless system that can be used in connection with various embodiments described herein.

### DETAILED DESCRIPTION

The disclosure and the various features and advantageous details thereof are explained more fully with reference to the non-limiting embodiments and examples that are described and/or illustrated in the accompanying drawings and detailed in the following. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

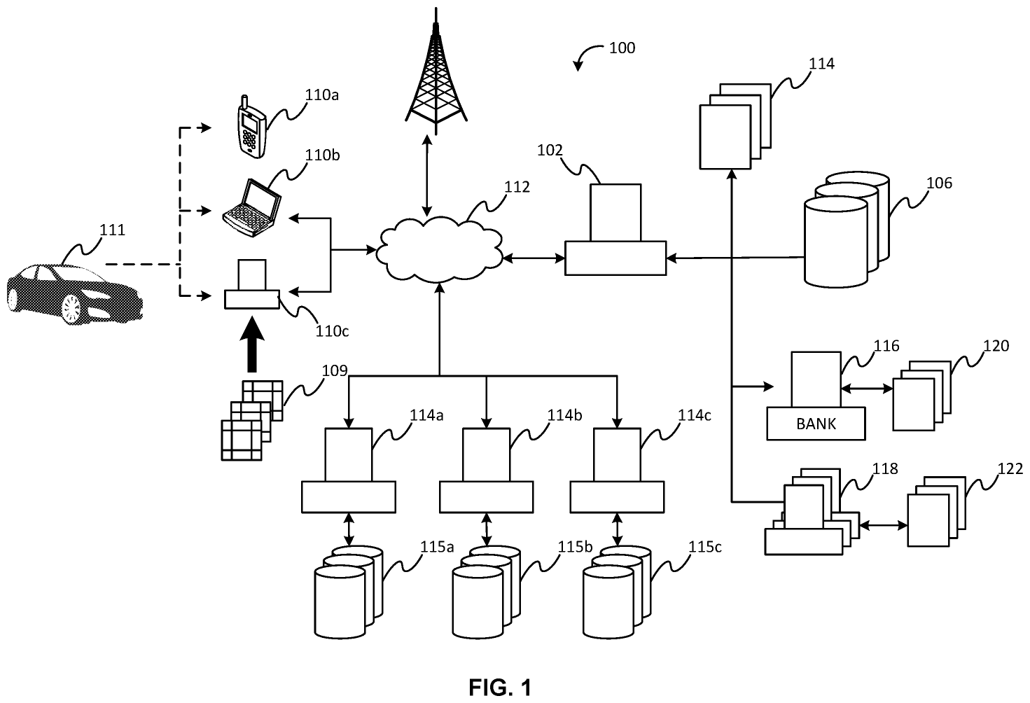

FIG. 1 is a diagram illustrating an example of a system 100 for automated used car pricing in accordance with one example embodiment. At the core of system 100 is a platform 102 and applications 109 that are downloaded to user devices 110. Platform 102 comprises the resources, hardware and software required to perform the functions and processes described herein. As such, platform 102 can comprises one or more servers, processors, user interfaces, programs 104, etc. These resources can be co-located, or located at multiple locations. Platform 102 is interfaced with a plurality of storage devices 106 configured to store data needed to perform the functions and processes described and/or produced as a result of these functions and processes.

Devices 110 can include anytime of user device configured to perform the functions and processes described herein. These devices 110 can include mobile devices, such as smartphones 110a, laptop or tablet devices 110b, and desktop computers 110c. As such, devices 110 can communicate with platform 102 via wired and/or wireless communication capabilities via network 112.

Once application 109 is downloaded to a device 110, a user can use application 109 to provide information to platform 102 in order to obtain a quote for their used car. As described below, in certain embodiment, platform 102 can also make an automatic payment or deposit into an account associated with the user.

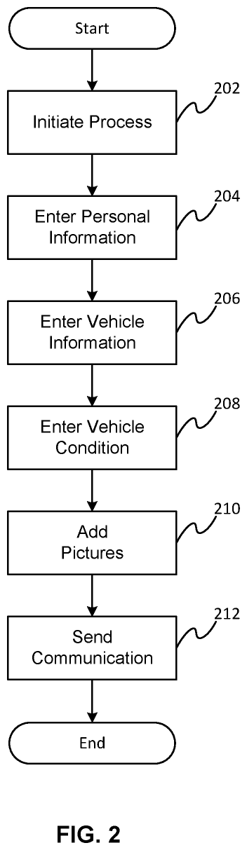

FIG. 2 is a diagram illustrating an example process for submitting information to platform 102 using application 109 in accordance with one embodiment. The process of FIG. 2 begins when a person launches application 102 and starts the process to get a quote in step 202 for their used car 111. This can cause application 109 to display a user interface on a display (not shown) included in device 110. The user interface can include fields where the user can input user information such as their name, contact information, e.g., email address, phone number, etc., and address and/or zip code. The user interface can also present fields into which the user can input vehicle information is step 204. The vehicle information can include such information as year of the vehicle, make of the vehicle, model of the vehicle, VIN number, miles, and license plate information.

In certain embodiments, some or all of the vehicle information can be input via video or pictures of car 111. For example, the user can take a picture of the VIN number and either application 109 or platform 102 can use, e.g., computer vision or image analytics to determine the VIN number. The same type of techniques can be used to determine the other vehicle information as well.

In step 206, the user can then input information related to the vehicles condition. This information can include whether the vehicle has been in an accident and how many, whether the vehicle runs, whether the vehicle has been smoked in, whether the vehicle includes after-market parts, whether the title is clear, whether any warning lights are activated, whether the vehicle has mechanical issues, and whether the interior is damaged, as well as the overall condition of the car.

In step 208, the user can add pictures of the exterior and/or interior of the car. It should be noted that pictures or video can be captured using device 110 or can be captured separately and uploaded via device 110.

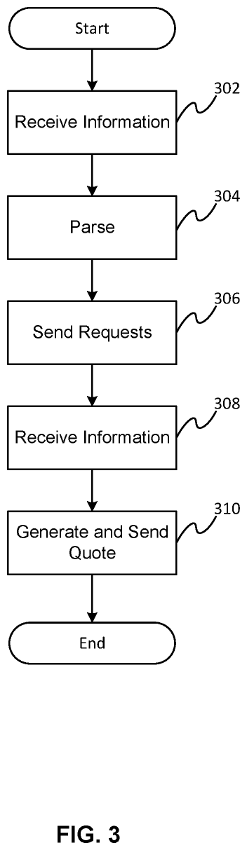

Once all of the information is gathered, application 109 can automatically generate a message, e.g., email or text that includes all of the information and that is to be sent to platform 102. Once the user confirms, the message will be sent in step 212. Platform 102 can be configured to then take the information provided and generate a quote as described in the flow chart of FIG. 3.

Platforms 102 can also be interfaced with one or more third party platforms 114a-c that have access to databases 115a-c storing various car information. Thus, when platform 102 receives, in step 302, the communication sent in step 212, platform 102 can parse the information, in step 304, and then generate requests that are sent platforms 114 in step 306.

Examples of platforms 114 include car history sites such as CARFAX, Autocheck; car valuation sites such as Black Book, Kelly Blue Book, Manheim.com, NADA; and market reports. In certain embodiments, this information can actually aggregated by an intermediary third party platform such as Autoniq. Platforms 114 then generate information and feedback that allows platform 102 to generate a quote for car 111 in step 310 after having received the information in step 308.

In certain embodiments, the user may have their own quote that can be provided, e.g., along with the information provided with via the process of FIG. 2 or in response to the quote generated in step 310. Platform 102 can be configured to determine whether to match the user's quote or not based on the information received in step 308.

If the user accepts the quote and determines to sell car 111, then platform 102 can, in certain embodiments, arrange and make a payment or credit an account related to the user. For example, platform 102 can be configured to automatically deposit the quoted amount into the user's bank account 120 at bank 116. This can be done via remote deposit capture or mobile deposit capabilities, although typically these capabilities are used by individuals or institutions to deposit checks into their own account. But in certain embodiments, the user can provide their bank account and platform 102 can be configured to automatically deposit a check into the users account. In certain embodiments, platform 102 can use a service 118 such as venom to credit a user's account 122.

Often, when a used car is purchased the car ends up at auction. In certain embodiments, once the user accepts the quote, car 111 is picked up and sent to auction. When the car is auctioned, video of the auction can be obtained and uploaded to platform 102, which can be configured to forward it to the device 114 associated with the user. The user can then use application 109 to view the video to confirm the auction price and platform 102 can be configured to automatically deposit or credit a second amount equal to a percentage of the difference between the quote generated in step 310 and the auction sales price. For example, the second payment or second check can be equal to 70% of the difference between the quote and the auction price.

Because there are so many auctions, platform can actually be configured to estimate, using data from platforms 114 and/or data stored in storage locations 106 to estimate using algorithms 104 the second payment and pay that estimate at the same time as the first payment. Any difference can then be accounted for after the auction.

Algorithms 104 must be finely tuned to ensure that the estimated amount is close to but without going over the actual amount of the second payment. This is because it is not feasible for a variety of reasons to try and take money back from the user if algorithms overestimated the payment. On the other hand, if the estimate is too far off, it negates at least some of the benefit of performing the estimate and making the advanced payment.

As such, the information stored in databases 106 is specific to the actual cars obtained through platform 102. Thus, this information can be combined with more general information provided by platforms 114 to more finely tune the estimates of the second payment.

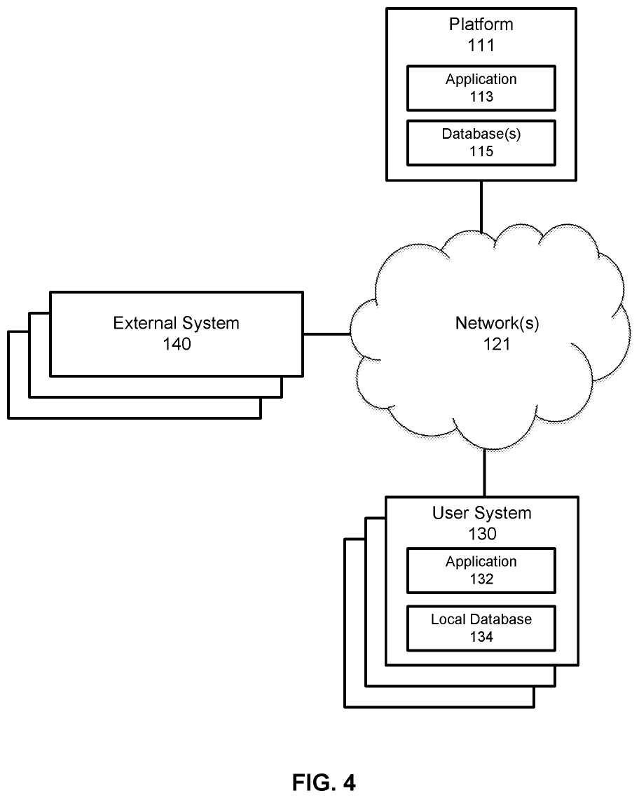

FIG. 4 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the processes, methods, or functions of the application described herein.

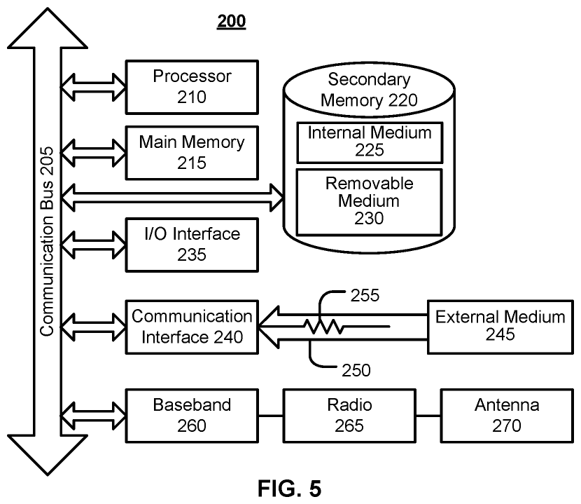

FIG. 5 is a block diagram illustrating an example wired or wireless system 550 that can be used in connection with various embodiments described herein. For example the system 550 can be used as or in conjunction with one or more of the platforms 102, devices 110 or processes described above, and may represent components of device, the corresponding backend server(s), and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system comprising:
a device comprising an application and a display, the application configured to present a user interface on the display that allows a user to provide user information, vehicle information and vehicle condition information;
a platform in communication with the device, with at least one storage location, and third party platforms, the platform configured to:
receive the user information, vehicle information and vehicle condition information in relation to a request for quote to purchase a car;
parse the user information, vehicle information and vehicle condition information;
generating one or more requests for related vehicle information that are sent to the third party platforms;
receive the related vehicle information;
generate a quote for the car based on the user information, vehicle information, vehicle condition information, and the related information; and
estimate a second payment that is equal to a percentage of the difference between the quote and an action price for the car.

2. The system of claim 1, wherein the device comprises a camera and wherein at least some of the user information, vehicle information and vehicle condition information are obtained via the camera, and wherein the platform is configured to parse the user information, vehicle information and vehicle condition information using computer vision and/or image analytics.

3. The system of claim 1, wherein the platform is further configured to automatically deposit the quoted amount and the second payment directly into an account associated with the user, or to automatically credit an account associated with the user.

4. A system comprising:
a device comprising an application and a display, the application configured to present a user interface on the display that allows a user to provide user information, vehicle information and vehicle condition information, wherein the device comprises a camera and wherein at least some of the user information, vehicle information and vehicle condition information are obtained via the camera;
a platform in communication with the device, with at least one storage location, and third party platforms, the platform configured to:
receive the user information, vehicle information and vehicle condition information in relation to a request for quote to purchase a car;
parse the user information, vehicle information and vehicle condition information, wherein the platform is configured to parse the user information, vehicle information and vehicle condition information using computer vision and/or image analytics;
generating one or more requests for related vehicle information that are sent to the third party platforms;
receive the related vehicle information; and
generate a quote for the car based on the user information, vehicle information, vehicle condition information, and the related information

5. The system of claim 4, wherein the platform is further configured to estimate a second payment that is equal to a percentage of the difference between the quote and an action price for the car.

6. The system of claim 5, wherein the platform is further configured to automatically deposit the quoted amount and the second payment directly into an account associated with the user, or to automatically credit an account associated with the user.

7. A system comprising:
a device comprising an application and a display, the application configured to present a user interface on the display that allows a user to provide user information, vehicle information and vehicle condition information, wherein the device comprises a camera and wherein at least some of the user information, vehicle information and vehicle condition information are obtained via the camera;
a platform in communication with the device, with at least one storage location, and third party platforms, the platform configured to:
receive the user information, vehicle information and vehicle condition information in relation to a request for quote to purchase a car;
parse the user information, vehicle information and vehicle condition information, wherein the platform is configured to parse the user information, vehicle information and vehicle condition information using computer vision and/or image analytics;
generating one or more requests for related vehicle information that are sent to the third party platforms;
receive the related vehicle information; and
generate a quote for the car based on the user information, vehicle information, vehicle condition information, and the related information, wherein the platform is further configured to automatically deposit the quoted amount and the second payment directly into an account associated with the user, or to automatically credit an account associated with the user.

8. The system of claim 7, wherein the platform is further configured to estimate a second payment that is equal to a percentage of the difference between the quote and an action price for the car.
